(19) United States
(12) Patent Application Publication
(10) Pub. No.: US 2024/0272911 A1
(43) Pub. Date: Aug. 15, 2024

(54) ADJUSTMENT OF ADDRESS SPACE ALLOCATED TO FIRMWARE

(71) Applicant: Intel Corporation, Santa Clara, CA (US)

(72) Inventors: Ramamurthy KRITHIVAS, Gilbert, AZ (US); Eswaramoorthi NALLUSAMY, Cedar Park, TX (US); Anand K. ENAMANDRAM, Folsom, CA (US); Mahesh S. NATU, Folsom, CA (US); Eric J. DEHAEMER, Shrewsbury, MA (US); Filip SCHMOLE, Portland, OR (US); Bharat S. PILLILLI, El Dorado Hills, CA (US)

(21) Appl. No.: 18/645,295

(22) Filed: Apr. 24, 2024

Related U.S. Application Data
(60) Provisional application No. 63/611,113, filed on Dec. 15, 2023.

(51) Int. Cl. G06F 9/4401

(52) U.S. Cl. CPC G06F 9/4403

(57) ABSTRACT

Examples described herein relate to an apparatus that includes an interface and circuitry to: prior to boot of a processor, configure a memory address decoder to increase a memory region size associated with firmware access from a first size to a second size, wherein the second size is larger than the first size. In some examples, the memory address decoder is to decode an address space in a Serial Peripheral Interface (SPI) flash device to determine a location of a Firmware Interface Table (FIT) in the second size of the memory region and the second circuitry is to access an entry in the FIT to determine a location of a boot firmware.

### RELATED APPLICATION

This application claims priority from U.S. Provisional Application No. 63/611,113, filed Dec. 15, 2023. The entire content of that application is incorporated by reference in its entirety.

### BACKGROUND

Computer systems include central processing units (CPUs) that execute instructions to perform data processing operations. After a computer system is powered on, a CPU loads and executes Basic Input/Output System (BIOS) and configuration information from flash memory. The executed-BIOS manages data flow between the computer's operating system (OS) and devices, such as a memory device or a network interface device. A Firmware Interface Table (FIT) is a data structure stored in the flash memory and includes multiple entries. An entry defines the starting address and attributes of different components in the BIOS or microcode.

### BRIEF DESCRIPTION OF THE DRAWINGS

FIG. 1 depicts an example system.

FIG. 2 depicts an example system.

FIG. 3 depicts of socket partitioning.

FIG. 4 depicts an example process.

FIG. 5 depicts an example system.

### DETAILED DESCRIPTION

With an increasing number of processors and microcontrollers in a computer system, there is an increasing number of corresponding firmware images. Accordingly, the size of a FIT table increases. However, if a FIT table is restricted in size, entries pointing to firmware and microcode to be loaded by a processor or microcontroller may not be stored in the FIT table.

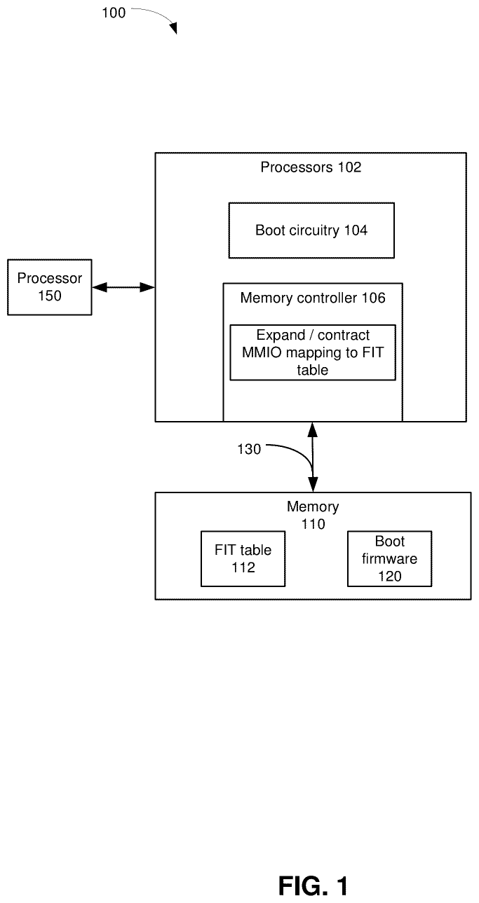

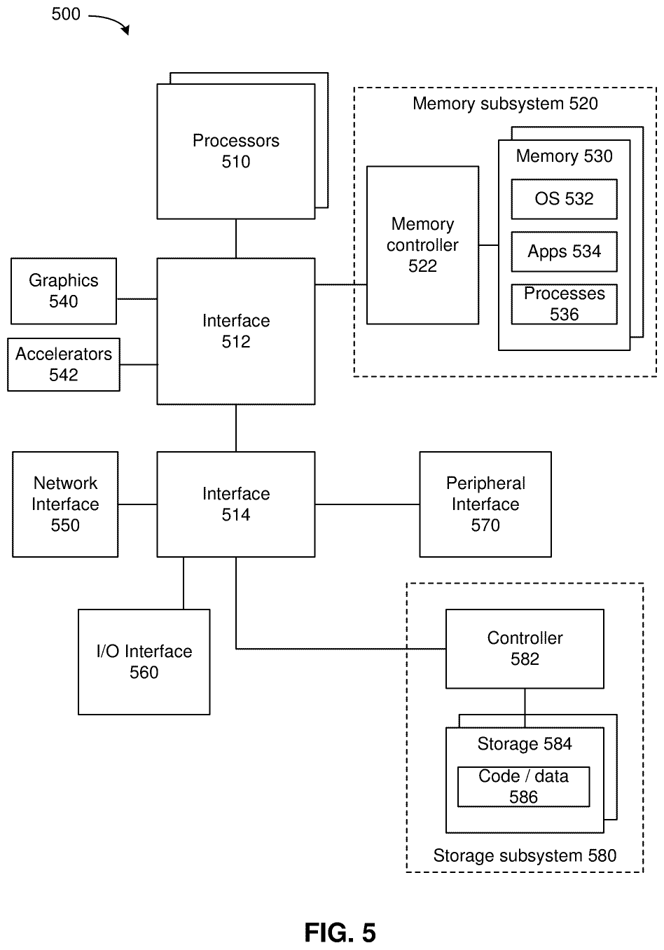

FIG. 1 depicts an example computing system 100. System 100 may include one or more processors 102 (generally referred to herein as processor 102). System 100 may include circuitry and/or software described at least with respect to FIG. 5. In some examples, processor 102 may include one or more processor cores (not shown), a cache (not shown), and/or a system agent (not shown). A processor core can include an execution core or computational engine that is capable of executing instructions. A core can access to its own cache and read only memory (ROM), or multiple cores can share a cache or ROM. Cores can be homogeneous (e.g., same processing capabilities) and/or heterogeneous devices (e.g., different processing capabilities). Frequency or power use of a core can be adjustable. A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others. Any type of inter-processor communication techniques can be used, such as but not limited to messaging, inter-processor interrupts (IPI), inter-processor communications, and so forth. Cores can be connected in any type of manner, such as but not limited to, bus, ring, or mesh. Cores may be coupled via an interconnect to a system agent (uncore).

A system agent can include a shared cache which may include any type of cache (e.g., level 1, level 2, or last level cache (LLC)). A system agent can include or more of: memory controller 106, a shared cache, a cache coherency manager, arithmetic logic units, floating point units, core or processor interconnects, or bus or link controllers. A system agent or uncore can provide one or more of: direct memory access (DMA) engine connection, non-cached coherent master connection, data cache coherency between cores and arbitrate cache requests, or Advanced Microcontroller Bus Architecture (AMBA) capabilities. The system agent or uncore can manage priorities and clock speeds for receive and transmit fabrics and memory controllers.

Processors 102 can access memory 110 through a memory controller 106. For example, memory 110 may include non-volatile memory such flash memory accessible through interface 130, such as a Serial Peripheral Interface (SPI) and/or enhanced SPI (eSPI) consistent interface, or other type of interface (e.g., System Management Bus (SMBus), I2C, MIPI I3C®, or others). In some examples, memory controller 106 may include circuitry (e.g., SPI controller) to control access to one or more Non-Volatile Memory (NVM) devices (e.g., illustrated as memory 110, where the one or more NVM devices may be provided on the same integrated circuit die in some examples) and/or allow for sharing of memory 110.

In some examples, contents of memory 110 can be memory mapped to host address space to allow access, during a process boot sequence or a process reset sequence, to entries in FIT table 112. FIT table 112 can be directed mapped to memory so that a processor can load firmware code by addressing memory 110. For example, entries in FIT table 112 can include entries with pointers to memory locations in memory 110 (or other memory device) of firmware 120 (e.g., boot firmware, microcode (uCode), a firmware patch, digitally signed modules that contain code to be run before the x86 CPU reset vector, or others).

For example, a data center administrator, firmware, or others can program a memory mapped input (MMIO) decoder of memory controller 106 to allocate a memory address window of FIT table 112 to boot circuitry 104 (e.g., integrated boot logic (IBL)) so that boot circuitry 104 can access FIT table 112 by an access to memory 110. As described herein, a processor socket 150 can communicate with processors 102 to determine a storage location of boot firmware in FIT table 112 and access the boot firmware. For example, by MMIO, devices can be read from or write-to by instructions that read from or write to memory. In some examples, memory controller 106, or other circuitry (e.g., home agent (HA), cache agent (CA), and/or cache and home agent (CHA)) or processor executed software (e.g., high-speed IO processor (HIOP) in an input/output stack) can include a decoder configured with a system address map to securely translate host address space addresses to physical addresses associated with FIT table 112 in memory 110.

Some examples can expand a memory mapped direct decode to access contents of FIT table 112 from 16 MB to 128 MB, or other sizes. Some examples can decrease a memory mapped direct decode to access contents of FIT table 112 from 128 MB to 16 MB, or other sizes. For example, a decode window size can be configurable via fuses/straps to set the decode window to a particular size. CHA decoders can allow or disallow core-initiated MMIO accesses to FIT table 112 whereas HIOP decoders can allow or disallow MMIO accesses to FIT table 112 by IO connected devices (e.g., Compute Express Link (CXL) or Peripheral Component Interconnect express (PCIe) connected devices).

In at least one addressable region in memory 110 that stores FIT table 112 and/or boot firmware 120, various examples can utilize a confidential computing environment or secure enclave using one or more of: total memory encryption (TME), multi-key total memory encryption (MKTME), Trusted Domain Extensions (TDX), Double Data Rate (DDR) encryption, function as a service (FaaS) container encryption or an enclave/TD (trust domain), Intel® SGX, Intel® TDX, AMD Memory Encryption Technology, AMD Secure Memory Encryption (SME) and Secure Encrypted Virtualization (SEV), AMD Secure Encrypted Virtualization-Secure Nested Paging (AMD SEV-SNP), ARM® TrustZone®, ARM® Realms and Confidential Compute, Apple Secure Enclave Processor, Qualcomm® Trusted Execution Environment, Distributed Management Task Force (DMTF) Security Protocol and Data Model (SPDM) specification, virtualization-based isolation such as Intel VTd and AMD-v, or others.

Encryption or decryption of data stored in memory 110 can be based on, for example, total memory encryption (TME) and multi-key total memory encryption (MKTME) commercially available from Intel Corporation (as described in the Intel Architecture Memory Encryption Technologies Specification version 1.1 dated Dec. 17, 2017, earlier versions, revisions, and variations thereof), components that make up TME and MKTME, the manner in which TME and MKTME operate, and so forth. TME provides a scheme to encrypt data by memory interfaces whereby memory controller 106 encrypts the data flowing to memory 110 or decrypts data flowing from memory 110 and provides plain text for processing by processor 102.

In some examples, TME is a technology that encrypts a device's entire memory or portion of a memory with a key. When enabled via basic I/O system (BIOS) (or Universal Extensible Firmware Interface (UEFI), or a boot loader) configuration, TME can provide for memory accessed by a processor on an external memory bus to be encrypted, including customer credentials, encryption keys, and other intellectual property (IP) or personal information. TME supports a variety of encryption algorithms and in one embodiment may use a National Institute of Standards and Technology (NIST) encryption standard for storage such as the advanced encryption system (AES) XTS algorithm with 128-bit keys. The encryption key used for memory encryption is generated using a hardened random number generator in the processor and is never exposed to software. Data in memory 110 and on the external memory buses can be encrypted and is in plain text while inside processor 102.

In some examples, TME can support multiple encryption keys (Multi-Key TME (MKTME)) and can provide the ability to specify the use of a specific key for a page of memory. This architecture allows either public-private key pairs or tenant-provided keys, giving full flexibility to customers. Processes can be cryptographically isolated from each other in memory with separate encryption keys which can be used in multi-tenant cloud environments. Processes can also be pooled to share an individual key, further extending scale and flexibility.

In some examples, circuitry in processors 102 can perform authentication of an entry in FIT table 112 before utilizing the entry to access boot firmware 120. In some examples, circuitry in processors 102 can perform authentication of boot firmware 120 prior to execution of boot firmware 120. In some examples, secure boot using boot firmware 120 based on an entry in FIT table 112 can utilize one or more of: AMD Platform Secure Boot (PSB), ARM Secure boot, Intel® Boot Guard technology, UEFI Secure Boot, or others.

Authentication of an entry in FIT table 112 and/or boot firmware 120 can include determining if certificate associated with the patch or a calculation matches an expected certificate or value. The certificate can be compatible with X.509 or other standards such as Simple Product Key Infrastructure (SPKI) or Pretty Good Privacy (PGP). An X.509 certificate can include a digital certificate that uses X.509 public key infrastructure (PKI) standard to verify that a public key belongs to a user. If authentication fails (not shown), however, the patch can be rejected and an administrator alerted to take action and identify potentially malicious behavior to access a firmware or to update certificates used for authentication. Verification can include decrypting the patch using a key. For example, elliptic-curve Diffie-Hellman (ECDH) key agreement protocol can be used where parties having an elliptic-curve public-private key pair to establish a shared secret. Other schemes can be used such as Triple Data Encryption Standard (3DES), Advanced Encryption Standard (AES), Digital Signature Algorithm (DSA), Rivest-Shamir-Adleman (RSA) algorithm, Elliptic Curve Digital Signature Algorithm (ECDSA), or others. A watchlist or deny list can be checked to see if the firmware update corresponds to a non-permitted firmware update.

In some examples, mapping of MMIO address to physical memory addresses can be as follows. For a first (e.g., legacy) (boot) socket (e.g., processor 102), during a reset sequence, firmware can configure local memory MMIO decoder to direct access to a particular 128 MB memory address range, corresponding to FIT table 112, to socket IBL (e.g., boot circuitry 104). For a second (e.g., non-legacy) socket (e.g., processor 150), during a reset sequence, firmware can configure local MMIO decoder to direct access to a particular 128 MB memory address range to the socket IBL (e.g., boot circuitry 104) so that core accesses to the 128 MB range are allowed but if a PCle or CXL connected device initiates an MMIO access to the 128 MB range, such accesses can be aborted by the HIOP.

In some examples, boot firmware code or firmware can include one or more of: microcode, digitally signed modules that contain code to be run before the x86 CPU reset vector, Basic Input/Output System (BIOS), Universal Extensible Firmware Interface (UEFI), or a boot loader. The BIOS firmware can be pre-installed on a personal computer's system board or accessible through an SPI interface from a boot storage (e.g., flash memory). In some examples, firmware can include SPS. In some examples, a Universal Extensible Firmware Interface (UEFI) can be used instead or in addition to a BIOS for booting or restarting cores or processors. UEFI is a specification that defines a software interface between an operating system and platform firmware. UEFI can read from entries from disk partitions by not just booting from a disk or storage but booting from a specific boot loader in a specific location on a specific disk or storage. UEFI can support remote diagnostics and repair of computers, even with no operating system installed. A boot loader can be written for UEFI and can be instructions that a boot code firmware can execute and the boot loader is to boot the operating system(s). A UEFI bootloader can be a bootloader capable of reading from a UEFI type firmware.

A UEFI capsule is a manner of encapsulating a binary image for firmware code updates. But in some examples, the UEFI capsule is used to update a runtime component of the firmware code. The UEFI capsule can include updatable binary images with relocatable Portable Executable (PE) file format for executable or dynamic linked library (dll) files based on COFF (Common Object File Format). For example, the UEFI capsule can include executable (*.exe) files. This UEFI capsule can be deployed to a target platform as an SMM image via existing OS specific techniques (e.g., Windows Update for Azure, or LVFS for Linux).

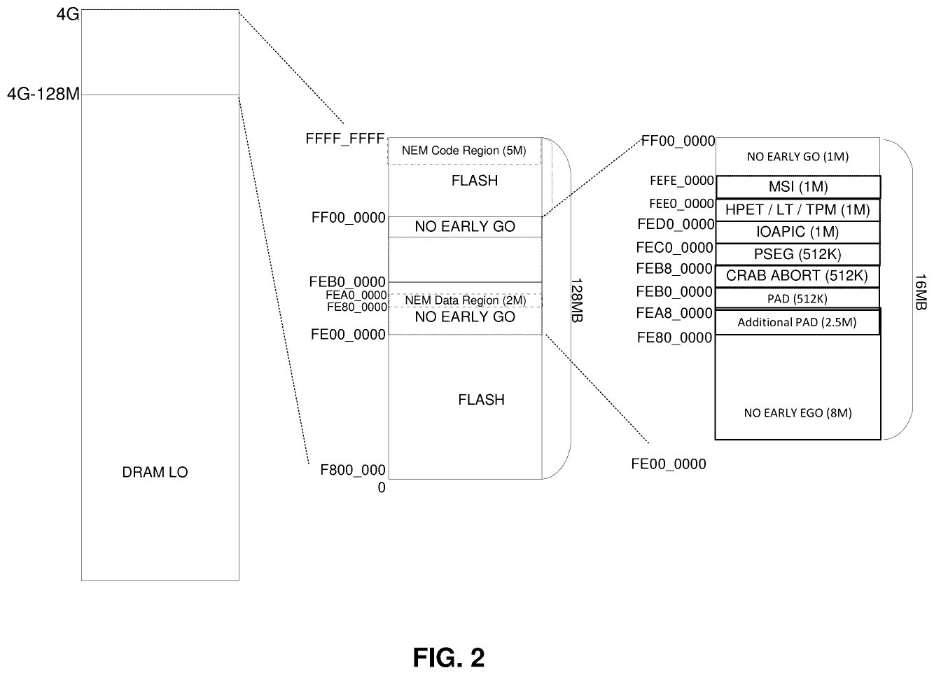

FIG. 2 below depicts an example of allocation of entries of a FIT table in memory. This example shows allocation of 128 MB to a FIT table. While examples refer to 128 MB, other sizes of memory can be allocated to a FIT table.

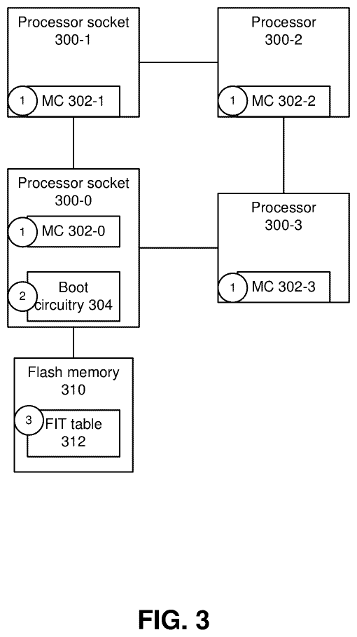

FIG. 3 depicts an example operation. At (1), sockets 300-0 to 300-3 are configured to expand a size of a FIT table 312 that includes entries that indicate locations in memory 310 or other memory of boot firmware and/or microcode. For example, a size of FIT table 312 can be adjusted based at least on changes to the following of one or more of sockets 300-0 to 300-3: register content, firmware, and/or power management code (p-code) executed by power management unit(s).

At (2), one or more of processor sockets 300-1 to 300-3 can access boot firmware and/or microcode from flash memory 310 via connection to processor socket 300-0. A connection can be consistent with socket interconnection standards such as Advanced Micro Devices, Inc. (AMD), AMD HyperTransport, NVIDIA® NVLink, Intel® QuickPath Interconnect (QPI), Advanced Microcontroller Bus Architecture (AMBA), Coherent Hub Interface(CHI) Chip to Chip (C2C), TileLink, RISC-V processor interconnect, Intel® Ultra Path Interconnect (UPI), Intel® On-Chip System Fabric (IOSF), Omnipath, Compute Express Link (CXL) (see, for example, Compute Express Link Specification revision 2.0, version 0.7 (2019), as well as earlier versions, later versions, and variations thereof), Peripheral Component Interconnect express (PCIe) (see, for example, Peripheral Component Interconnect (PCI) Express Base Specification 1.0 (2002), as well as earlier versions, later versions, and variations thereof), or other public or proprietary standards.

Processor socket 300-0 can access FIT table 312 from flash memory 310 to determine a location of an entry in FIT table 312 that identifies locations of boot firmware and/or microcode in memory 310 or other memory. For example, socket 300-0 can receive requests for entries from processor sockets 300-1 to 300-3, and send the requests to boot circuitry 304. Based on the requester being permitted to access FIT table 312, boot circuitry 304 can send the request to flash memory 310 to read FIT table 312. Based on the requester not being permitted to access FIT table 312, boot circuitry 304 may not send the request to flash memory 310 to read FIT table 312 or alert an administrator of an unauthorized attempt to access FIT table 312.

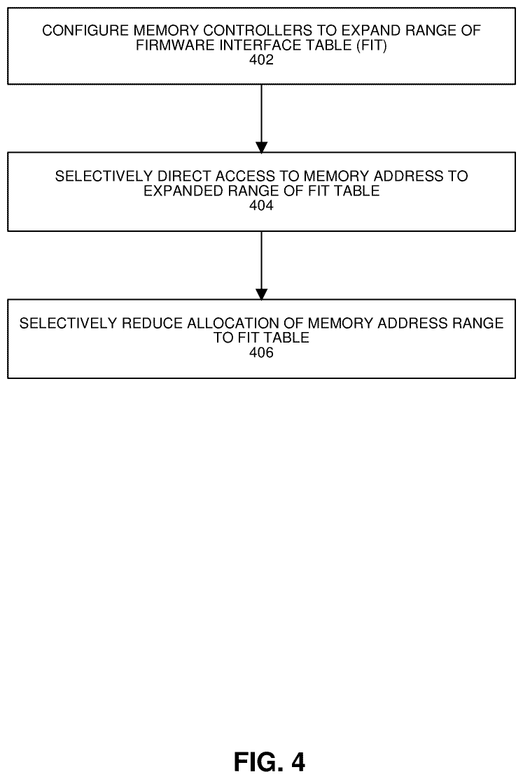

FIG. 4 depicts an example process. The process can be performed by a memory controller at the request of an orchestrator or data center administrator. At 402, one or more memory controllers can be configured to increase a memory mapped region of memory allocated to a table that identifies stored locations of boot firmware and/or other code in memory. For example, a firmware (e.g., boot firmware) can adjust the configuration of the one or more memory controllers. The configuration can identify a particular requester (e.g., CPU socket or connected device) that is permitted to access the memory mapped region of memory. Adjustment of the configuration can occur prior to a processor boot sequence or processor reset sequence.

At 404, based on receipt of a request to access boot firmware and a requester, the memory controller can issue the request to the memory mapped region to access an entry that identifies a memory address location of the boot firmware. For example, a core of a particular socket can be permitted to access the memory mapped region but a PCle or CXL connected device may not be permitted to access content of the memory mapped region.

At 406, after access to the boot firmware, the memory mapped region of memory allocated to the table that identifies stored locations of boot firmware and/or other code in memory can be reduced. For example, the memory mapped region of memory allocated to the table that can be reduced during or after a boot sequence or during or after a reset sequence. Reducing the size of the memory mapped region of memory can free memory for other uses.

FIG. 5 depicts a system. In some examples, circuitry of system 500 can be configured to adjust a size of a table indicative of locations of boot firmware and selectively permit access to the table, as described herein. System 500 includes processor 510, which provides processing, operation management, and execution of instructions for system 500. Processor 510 can include any type of microprocessor, central processing unit (CPU), graphics processing unit (GPU), XPU, processing core, or other processing hardware to provide processing for system 500, or a combination of processors. An XPU can include one or more of: a CPU, a graphics processing unit (GPU), general purpose GPU (GPGPU), and/or other processing units (e.g., accelerators or programmable or fixed function FPGAs). Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 510 can include multiple processors and multiple processors can be embodied as processor sockets.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a programmable or fixed function offload engine that can be accessed or used by a processor 510. For example, an accelerator among accelerators 542 can provide data compression (DC) capability, cryptography services such as public key encryption (PKE), cipher, hash/authentication capabilities, decryption, or other capabilities or services. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510. For example, memory controller 522 can be configured to adjust a size of a table indicative of locations of boot firmware and selectively permit access to the table Applications 534 and/or processes 536 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 532 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory. Network interface 550 can receive data from a remote device, which can include storing received data into memory. In some examples, packet processing device or network interface device 550 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 500 includes one or more input/output (I/O) interface(s) 560. I/O interface 560 can include one or more interface components through which a user interacts with system 500. Peripheral interface 570 can include any hardware interface not specifically mentioned above. Peripherals refer generally to devices that connect dependently to system 500.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 500 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 500 can be implemented using interconnected compute platforms of processors, memories, storages, network interfaces, and other components. High speed interconnects can be used such as PCle, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.””

Illustrative examples of the devices, systems, and methods disclosed herein are provided below. An embodiment of the devices, systems, and methods may include any one or more, and any combination of, the examples described below.

An example includes circuitry connected to a processor, wherein the circuitry is to: adjust an address decode value via fuses and straps to set a decode window to an particular size. A firmware can program decoders and the boot logic to cover a programmed range.

Example 1 includes one or more examples and includes an apparatus that includes an interface and circuitry to: prior to boot of a processor, configure a memory address decoder to increase a memory region size associated with firmware access from a first size to a second size, wherein the second size is larger than the first size.

Example 2 includes one or more examples and includes a second circuitry and wherein: the memory address decoder is to decode an address space in a Serial Peripheral Interface (SPI) flash device to determine a location of a Firmware Interface Table (FIT) in the second size of the memory region; the second circuitry is to access an entry in the FIT to determine a location of a boot firmware; and the second circuitry is to load the boot firmware based on the determined location.

Example 3 includes one or more examples, wherein the memory address decoder is to provide access to a second processor to execute the firmware from within the second size of memory.

Example 4 includes one or more examples, wherein the first size comprises 16 MB and the second size comprises 128 MB.

Example 5 includes one or more examples, wherein the circuitry is to: after boot of the processor, release a portion of the second size of memory region from association with the firmware access.

Example 6 includes one or more examples, wherein the second size comprises a memory mapped input output (MMIO) address range.

Example 7 includes one or more examples, wherein: based on receipt of a request for boot firmware from the processor, the memory address decoder is to direct the request to a first region in the second size of the memory region to load the boot firmware and based on receipt of a second request for boot firmware from a second processor, the memory address decoder is to direct the second request to a second region in the second size of the memory region to load second boot firmware.

Example 8 includes one or more examples, wherein the firmware includes one or more of: microcode, Basic Input/Output System (BIOS), Universal Extensible Firmware Interface (UEFI), or a boot loader.

Example 9 includes one or more examples and includes at least one non-transitory computer-readable medium comprising instructions stored thereon, that if executed by one or more processors, cause the one or more processors to: increase a memory region size associated with firmware access from a first size to a second size, wherein the second size is larger than the first size and after boot of a processor from accessing the firmware, release a portion of the second size memory region from association with the firmware access.

Example 10 includes one or more examples and includes instructions stored thereon, that if executed by one or more processors, cause the one or more processors to: provide access to a second processor to execute the firmware from within the second size of memory.

Example 11 includes one or more examples and includes instructions stored thereon, that if executed by one or more processors, cause the one or more processors to: after boot of the processor, release a portion of the second size memory region from association with the firmware access.

Example 12 includes one or more examples, wherein the second size comprises a memory mapped input output (MMIO) address range.

Example 13 includes one or more examples, and includes instructions stored thereon, that if executed by one or more processors, cause the one or more processors to: based on receipt of a request for boot firmware from the processor, direct the request to a first region in the second size of the memory region to load the boot firmware and based on receipt of a second request for boot firmware from a second processor, direct the second request to a second region in the second size of the memory region to load second boot firmware.

Example 14 includes one or more examples, wherein the firmware includes one or more of: microcode, Basic Input/Output System (BIOS), Universal Extensible Firmware Interface (UEFI), or a boot loader.

Example 15 includes one or more examples, and includes a method that includes: prior to booting a processor, increasing a memory region size associated with firmware access from a first size to a second size, wherein the second size is larger than the first size.

Example 16 includes one or more examples, and includes providing access to a second processor to execute the firmware from within the second size of memory.

Example 17 includes one or more examples, and includes after booting of the processor, releasing a portion of the second size memory region from association with the firmware access.

Example 18 includes one or more examples, wherein the second size comprises a memory mapped input output (MMIO) address range.

Example 19 includes one or more examples, and includes based on receipt of a request for boot firmware from the processor, directing the request to a first region in the second size of the memory region to load the boot firmware and based on receipt of a second request for boot firmware from a second processor, directing the second request to a second region in the second size of the memory region to load second boot firmware.

Example 20 includes one or more examples, wherein the firmware includes one or more of: microcode, Basic Input/Output System (BIOS), Universal Extensible Firmware Interface (UEFI), or a boot loader.

1. An apparatus comprising:
an interface and
circuitry to:
prior to boot of a processor, configure a memory address decoder to increase a memory region size associated with firmware access from a first size to a second size, wherein the second size is larger than the first size.

2. The apparatus of claim 1, comprising a second circuitry and wherein:
the memory address decoder is to decode an address space in a Serial Peripheral Interface (SPI) flash device to determine a location of a Firmware Interface Table (FIT) in the second size of the memory region;
the second circuitry is to access an entry in the FIT to determine a location of a boot firmware; and
the second circuitry is to load the boot firmware based on the determined location.

3. The apparatus of claim 1, wherein the memory address decoder is to provide access to a second processor to execute the firmware from within the second size of memory.

4. The apparatus of claim 1, wherein the first size comprises 16 MB and the second size comprises 128 MB.

5. The apparatus of claim 1, wherein the circuitry is to:
after boot of the processor, release a portion of the second size of memory region from association with the firmware access.

6. The apparatus of claim 1, wherein the second size comprises a memory mapped input output (MMIO) address range.

7. The apparatus of claim 1, wherein:
based on receipt of a request for boot firmware from the processor, the memory address decoder is to direct the request to a first region in the second size of the memory region to load the boot firmware and
based on receipt of a second request for boot firmware from a second processor, the memory address decoder is to direct the second request to a second region in the second size of the memory region to load second boot firmware.

8. The apparatus of claim 1, wherein the firmware includes one or more of: microcode, Basic Input/Output System (BIOS), Universal Extensible Firmware Interface (UEFI), or a boot loader.

9. At least one non-transitory computer-readable medium comprising instructions stored thereon, that if executed by one or more processors, cause the one or more processors to:
increase a memory region size associated with firmware access from a first size to a second size, wherein the second size is larger than the first size and
after boot of a processor from accessing the firmware, release a portion of the second size memory region from association with the firmware access.

10. The at least one non-transitory computer-readable medium of claim 9, comprising instructions stored thereon, that if executed by one or more processors, cause the one or more processors to:
provide access to a second processor to execute the firmware from within the second size of memory.

11. The at least one non-transitory computer-readable medium of claim 9, comprising instructions stored thereon, that if executed by one or more processors, cause the one or more processors to:
after boot of the processor, release a portion of the second size memory region from association with the firmware access.

12. The at least one non-transitory computer-readable medium of claim 9, wherein the second size comprises a memory mapped input output (MMIO) address range.

13. The at least one non-transitory computer-readable medium of claim 9, comprising instructions stored thereon, that if executed by one or more processors, cause the one or more processors to:
based on receipt of a request for boot firmware from the processor, direct the request to a first region in the second size of the memory region to load the boot firmware and
based on receipt of a second request for boot firmware from a second processor, direct the second request to a second region in the second size of the memory region to load second boot firmware.

14. The at least one non-transitory computer-readable medium of claim 9, wherein the firmware includes one or more of: microcode, Basic Input/Output System (BIOS), Universal Extensible Firmware Interface (UEFI), or a boot loader.

15. A method comprising:
prior to booting a processor, increasing a memory region size associated with firmware access from a first size to a second size, wherein the second size is larger than the first size.

16. The method of claim 15, comprising:
providing access to a second processor to execute the firmware from within the second size of memory.

17. The method of claim 15, comprising:
after booting of the processor, releasing a portion of the second size memory region from association with the firmware access.

18. The method of claim 15, wherein the second size comprises a memory mapped input output (MMIO) address range.

19. The method of claim 15, comprising:
based on receipt of a request for boot firmware from the processor, directing the request to a first region in the second size of the memory region to load the boot firmware and
based on receipt of a second request for boot firmware from a second processor, directing the second request to a second region in the second size of the memory region to load second boot firmware.

20. The method of claim 15, wherein the firmware includes one or more of: microcode, Basic Input/Output System (BIOS), Universal Extensible Firmware Interface (UEFI), or a boot loader.
